(19) United States
(12) Patent Application Publication
(10) Pub. No.: US 2004/0266428 A1
(43) Pub. Date: Dec. 30, 2004

(54) Controlling roaming in mobile terminal

(75) Inventor: Janne U. Aaltonen, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/830,718

(22) Filed: Apr. 23, 2004

(30) Foreign Application Priority Data
Apr. 24, 2003 (FI) 20030617

(51) Int. Cl. H04M 1/00

(52) U.S. Cl. 455/432.1; 455/426.1; 455/557; 455/435.1

(57) ABSTRACT

The invention relates to controlling roaming in a mobile terminal which is capable of operating at least in networks according to first and second network technologies, and capable of operating in a home network and of roaming in one or more visited networks, said home network comprising at least a network according to said second network technology, and each visited network comprising at least a network according to one network technology. The mobile terminal is controlled (12) to operate in a home network mainly in a network according to said second network technology, and the operation of the mobile terminal in a network according to the second network technology is limited (13) in at least one visited network.

### CROSS REFERENCE TO RELATED APPLICATIONS

This application claims priority under 35 USC §119 to Finnish Patent Application No. 20030617 filed on Apr. 24, 2003.

### TECHNICAL FIELD

The invention relates to controlling roaming in a mobile terminal.

### BACKGROUND OF THE INVENTION

In telecommunications networks, roaming means a situation in which a terminal of a client of one operator operates in a network of another operator, that is, in a visited network. A condition for roaming is a roaming agreement between network owners (operators). Roaming may be international when a visited network exists in another country than the own operator's network, that is, a home network of the terminal, or national, when a visited network is in the same country as the home network. In the latter case, the service areas of home network and visited network often differ from each other.

Specifications set for third generation (3G) mobile communication systems are defined in the specifications of 3GPP (3^{rd} Generation Partnership Project). One mobile communications technology according to 3G standards specified by 3GPP is WCDMA (Wideband Code Division Multiple Access).

First 3G terminals are two-system devices, which may operate both in 3G networks and 2G networks, such as for example in a GSM (Global System for Mobile Communications) network. This enables flexible transition from utilising 2G networks to utilising 3G networks. According to WCDMA standard, roaming may be performed either in WCDMA or GSM network. Network selection performed in a terminal in a roaming situation has been described in, inter alia, 3GPP specification 23. 122 v 5.2.0 (2002-12).

The mandatory requirements set for terminals in the WCDMA standard are much more comprehensive than the mandatory requirements set for networks. In other words, such features, which must be implemented in terminals, may be optional on the network side. Thus, network manufacturers may decide more freely than terminal manufacturers which features are implemented in WCDMA networks and which are possibly not implemented. In addition, network manufacturers may freely decide in which schedule the features are implemented and how their testing is performed. Especially between networks of different network manufacturers, there may exist great differences in implementations and implementation schedules of different features. Furthermore, different operators may utilise different settings in their networks.

Because of this, the design of terminals for WCDMA networks is an extremely challenging task. In practice, it is necessary to test the compatibility of terminal features separately in the networks of all network manufacturers, because different network manufacturers may implement the requirements of 3GPP standards in different ways. In addition, the functionality of these features must be tested also in an actual environment, inter alia, in operative networks of different operators. It is thus not sufficient that one tests a terminal in a network of one network manufacturer or one operator, and assumes that the networks of other manufacturers and operators function in the same way.

Different operators utilise networks of different manufacturers; some of the operators utilise devices supplied by only one manufacturer in their networks, whereas some of the operators utilise devices supplied by many different manufacturers. Because different network manufacturers implement different features in differing schedules, all operators cannot have their 3G networks operative at the same time. From this follows that field testing in a network of one operator/network manufacturer may be performed much earlier than in a network of some other operator/network manufacturer.

### SUMMARY OF THE INVENTION

An invention has now been made, one starting point of which is the analysing of compatibility problems of terminals and networks related to transferring to 3G technology. An objective of the invention is to solve these problems, or at least minimise the disadvantages related to them.

An embodiment of the invention is based on a notion that the compatibility problem must be solved gradually so that early 3G terminals are first tested in networks implemented with a faster schedule, in order that the operators owning this kind of network could begin supplying their 3G services as soon as possible. Then the actual problem with these early 3G terminals becomes securing of roaming functionality in the 3G networks to be opened later in which these early 3G terminals could not be tested at that time.

A basic idea behind an embodiment of the invention in solving this problem is to permit the use of WCDMA only in a home network that has been established compatible with the terminal, and to force the terminal to operate according to 2G network technology when roaming. It is evident for those skilled in the art that the basic idea of the invention may also be applied in connection of other network technologies.

According to a first aspect of the invention, one implements a method for controlling roaming in a mobile terminal, which mobile terminal is capable of operating at least in networks according to first and second network technologies, and capable of operating in a home network and of roaming in one or more visited networks, said home network comprising at least a network according to said second network technology, and each visited network comprising at least a network according to the one network technology, said method comprising: controlling a mobile terminal to operate in a home network mainly in a network according to said second network technology; and limiting, at least in one visited network, the operation of said mobile terminal in a network according to said second network technology.

In an embodiment according to the invention, said home network comprises a network according to said first network technology, and a network according to said second network technology, and the mobile terminal is controlled to operate in a home network in a network according to said first network technology, if network resources according to said second network technology are not available.

A method according to another embodiment according to the invention further comprises registering into a new network, checking if said new network is a home network or a visited network, and controlling dynamically said mobile terminal to operate according to the first or the second network technology, if said new network is a home network, and according to the first technology, if said new network is a visited network.

The checking phase, in which one checks if the above-mentioned new network is a home network or a visited network, may be performed, for example, by comparing a network country code or a PLMN (Public Land Mobile Network) code obtained from the network in the registering phase with the network information saved on a SIM/USIM card or a memory of the mobile terminal.

At least one above-mentioned visited network may comprise, for example, a network according to the above-mentioned first network technology, and a network according to the above-mentioned second network technology.

The above-mentioned second network technology may be a newer network technology than the above-mentioned first network technology, and/or the above-mentioned mobile terminal may have been inadequately tested in visited networks according to the above-mentioned second network technology.

Furthermore, the above-mentioned second network technology may be, for example, a network technology according to the 3GPP standard, such as WCDMA technology, and the above-mentioned first network technology may be a network technology according to the GSM standard or a network technology according to the GPRS standard. This invention is not, however, limited to only these technologies but the invention may be applied in connection with any other network technology applicable to the context.

The invention may be applied to international or national roaming.

According to a second aspect of the invention, one implements a mobile terminal which is capable of operating at least in networks according to first and second network technologies, and capable of operating in a home network and of roaming in one or more visited networks, said home network comprising at least a network according to said second network technology, and each visited network comprising at least a network according to one network technology, said mobile terminal comprising control means for controlling the mobile terminal to operate in a home network mainly in a network according to said second network technology, which control means are arranged to limit, at least in one visited network, the operation of the mobile terminal in a network according to said second network technology.

A mobile terminal according to the invention may be any device, which may communicate with a data transmission network over a wireless transmission path. Such device may be, for example, a mobile phone, a smart phone, a palm computer or a laptop computer.

According to a third aspect of the invention, one implements a computer program to be run in a mobile terminal, which mobile terminal is capable of operating at least in networks according to first and second network technologies, and capable of operating in a home network and of roaming in one or more visited networks, said home network comprising at least a network according to said second network technology, and each visited network comprising at least a network according to one network technology, the computer program comprising a program code, which controls the mobile terminal to operate in a home network mainly in a network according to said second network technology, and a program code, which limits, at least in one visited network, the operation of the mobile terminal in a network according to said second network technology.

According to a fourth aspect of the invention, one implements a telecommunications system comprising at least one telecommunications network, which comprises at least networks according to first and the second network technology, the telecommunications system further comprising a mobile terminal, which is capable of operating at least in networks according to the first and second network technologies, and capable of operating in a home network and of roaming in one or more visited networks, said telecommunications network being a visited network for the mobile terminal, the mobile terminal comprising control means, which are arranged to limit the operation of said mobile terminal in a network according to said second network technology when said terminal is connected to said telecommunications network.

The dependent claims concern some embodiments of the invention. The contents of the dependent claims related to one aspect of the invention may also be applied to the other aspects of the invention.

An advantage of a certain embodiment of the invention is the solution for roaming-related compatibility problems of early terminals according to new network technologies, such as WCDMA terminals. Thus, operators may start the services according to new network technologies in different times without causing compatibility problems in the networks of other operators. This will expedite and facilitate the implementation of new network technologies.

### BRIEF DESCRIPTION OF THE DRAWINGS

The invention will now be described in detail by way of examples with reference to the accompanying figures, in which

FIG. 1 is a flow chart describing a method according to an embodiment of the invention;

FIG. 2 shows a simplified block diagram of a mobile terminal according to an embodiment of the invention; and

FIG. 3 shows a simplified block diagram of a telecommunications system applicable for implementing an embodiment of the invention.

### DETAILED DESCRIPTION

For clarity, the invention will next be described especially with the help of GSM and WCDMA technologies, but not limiting the invention only to these technologies.

As an example, let's assume the following situation of two operators to illustrate the problems related to transferring to new network technology:

Operator 1:

The WCDMA network of operator 1 is supplied by one network manufacturer, which has implemented the features according to the standard with fast schedule. Testing the compatibility of terminals and the network of operator 1 has gone well, and the operator is almost ready to start commercial WCDMA services with tested terminals.

Operator 2:

Operator 2 uses several network suppliers to construct its WCDMA network. Some of these network suppliers are slow in implementing all features according to the standard to their networks. Because of this, testing the compatibility of terminals and the network of operator 2 advances slowly. When operator 1 would be ready to start commercial WCDMA services in its network, the testing of terminals in the network of operator 2 is only in an early stage.

Thus, one finds oneself in a situation in which the WCDMA features of a certain terminal with a certain software version have been tested well in the network of operator 1, but the testing of the terminal has been very limited in the network of operator 2. Operator 1 starts commercial WCDMA services with this terminal version.

At a later time, also operator 2 finishes its WCDMA network for commercial launching. Assuming that operators 1 and 2 have a roaming agreement, a problem arises thus from the point of view of operator 1: the WCDMA standard requires that the terminal according to the standard may choose WCDMA network when roaming in a network of another operator, if the visited network in question comprises a WCDMA network. The early terminal operating in the WCDMA network of operator 1 could not, however, have been tested in the WCDMA network of operator 2, so the operation of these early terminals in the network of operator 2 is unforeseeable or even impossible. Thus, operator 1 cannot be sure if its customers will have service when roaming in the area of the network of operator 2.

Based on the above, one finds oneself in a situation in which

the functionality of early terminals in visited networks cannot be secured,

the terminal manufacturer must collect the early terminals back, and update their software into a version, which has been established to be compatible also with the network of operator 2, or

operator 1 must postpone launching its new services until the network of operator 2 is ready and tested, that is, all operators have to start offering WCDMA services at the same time.

Any of the above is not a well-reasoned solution to this problematic situation.

According to an embodiment of the invention, the problem of the above-mentioned situation is solved so that the early terminals operating in the network of operator 1 are forced to operate according to 2G technology when roaming in the network of operator 2 (or any other visited network).

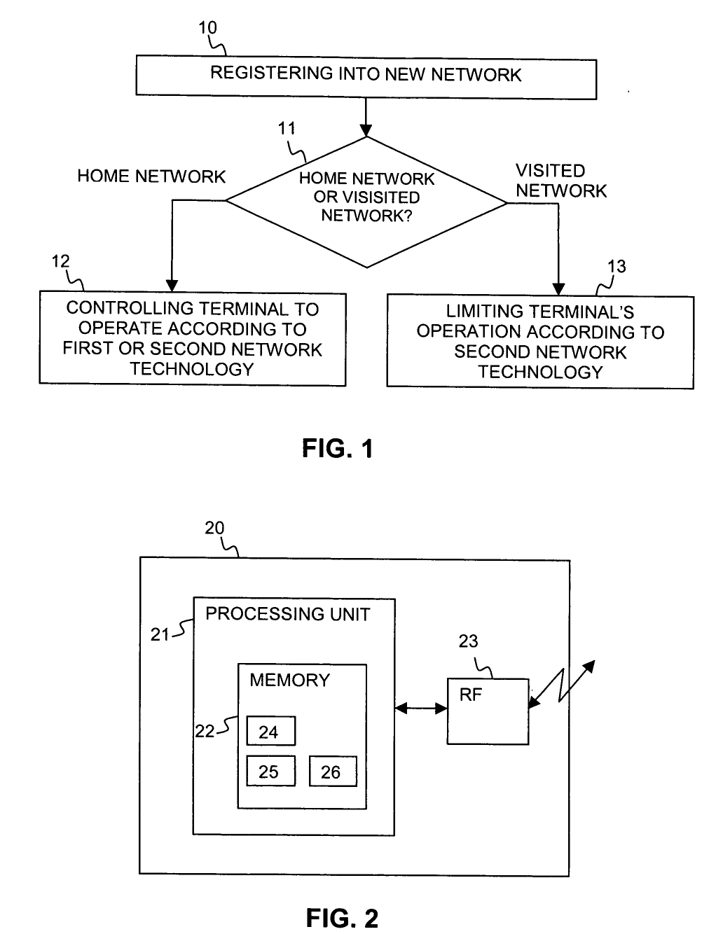

FIG. 1 is a flow chart describing a method according to an embodiment of the invention. In phase 10, the mobile terminal registers into a new network after which (or in connection with which) in phase 11 one checks if the above-mentioned new network is a home network or a visited network.

In connection with international roaming, this checking may be performed, for example, by comparing a network country code or a PLMN (Public Land Mobile Network) code obtained from the network in the registering phase with the network information saved on a SIM/USIM (Subscriber Identity Module/UMTS Subscriber Identity Module) card or a memory of the mobile terminal. When the terminal performs an initial network search and synchronisation after the terminal is switched on, the terminal decodes a network country code obtained from the network, and deduces on the basis of it in which network the terminal is situated. Based on the network information in a SIM/USIM card or a memory, the terminal knows the country code of its home network, and if the country code decoded from the network does not correspond to the home network country code on a SIM/USIM card or a memory, the terminal knows it is in a visited network.

The method for registering into network is not dealt with in detail in this context, because such procedure is known for those skilled in the art, and, furthermore, it is evident for those skilled in the art that the registering method may be implemented in different ways depending on, for example, the network technology used.

If the new network is a home network, the terminal is controlled to operate according to the first or second network technology in phase 12, and if the new network is a visited network, the operation of the terminal according to the second technology is limited in phase 13. The limitation of using the second network technology in a visited network may be accomplished, for example, by prohibiting the use of the second technology in visited networks. In other words, if the terminal is in a home network, the terminal continues its operation in the normal two-system (for example GSM/WCDMA) mode, and chooses a network according to either the first or the second (old or new) network technology according to the 3GPP standard. If the network is a visited network, the terminal continues network selection only according to the first (old) network technology (for example GSM). Thus, the old network technology is always chosen in a visited network regardless of whether the new network technology is also available in the visited network in question.

According to an embodiment of the invention, it is not exclusive that the terminal is capable of operating according to more than two network technologies. The fundamental matter is the classification into technologies established as functional in visited networks and into technologies the functionality of which is not established in visited networks; the use of the first ones is permitted in any network, and the use of the latter ones is enabled only in a home network. One should, however, notice that other external factors may set limitations to the use of different network technologies in different networks.

The invention may be realised as a part of software, which is run on a suitable platform, which may be, for example, a data processor in the mobile terminal. The invention may also be realised as other software and/or hardware implementation in a terminal.

FIG. 2 shows a simplified block diagram of a mobile terminal 20 according to an embodiment of the invention. Such mobile terminal may be any device, which can communicate with any data transmission network over a wireless transmission path, for example a mobile phone, a smart phone, a palm computer or a laptop computer. Terminal 20 comprises a processing unit 21, which in turn comprises a data processor (not shown) and a memory 22. The processing unit communicates with a radio part (RF) 23 via which the terminal 20 receives and sends information over a wireless data transmission path.

The processing unit 21 and radio part 23 are arranged to operate at least in different networks according to first and the second network technologies, for example, in GSM and WCDMA networks. In addition, the processing unit and radio part are arranged to operate in a home network, and in one or more visited networks, the home network comprising at least a network according to the second (WCDMA) network technology, and each visited network comprising networks according to one or more network technologies, such as networks according to GSM and WCDMA network technologies.

In memory 21 are saved a computer program code 24, which controls the mobile terminal to register into a new network, a computer program code 25, which is arranged to check if the above-mentioned new network is a home network or a visited network, and a computer program code 26, which is arranged to dynamically control the mobile terminal to operate according to the first or the second (for example, GSM or WCDMA) network technology, if the new network is a home network, and according to the first technology (for example, GSM), if the new network is a visited network.

Thus the computer program codes 24, 25 and 26 control the mobile terminal 20 to operate in a home network mainly in a network according to the above-mentioned second (WCDMA) network technology, and limit, at least in one visited network, the operation of the mobile terminal 20 in a network according to the second (WCDMA) network technology.

The computer program codes 24, 25 and 26 may be bundled in one computer program segment or in different segments of one computer program, or they may be parts of a larger software assembly.

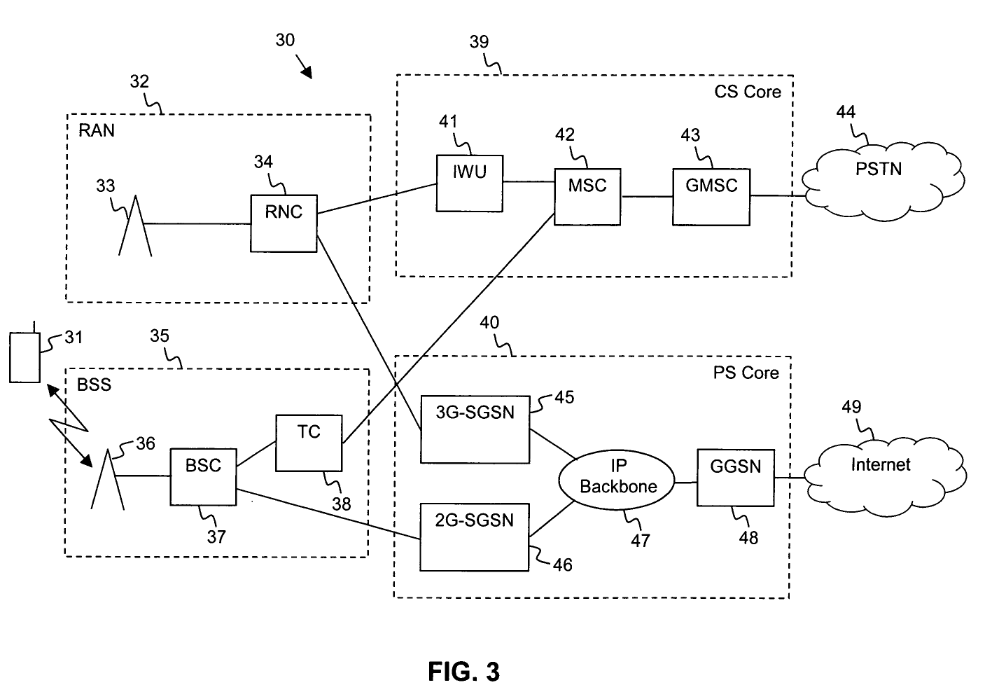

FIG. 3 shows a block diagram of a telecommunications system applicable for implementing an embodiment of the invention. The figure shows by way of examples a telecommunications network 30 of one operator which comprises networks according to both GSM and WCDMA technologies, and into which the mobile terminal 31 is connected.

A radio network 32 (RAN, Radio Access Network) according to WCDMA technology comprises a base station 33 (BS) and a radio network controller 34 (RNC). A radio network 35 (BSS, Base Station Subsystem) according to GSM technology comprises a base station 36 (BTS, Base Transceiver Station), a base station controller 37 (BSC) and a transcoder 38 (TC).

Telecommunications network 30 comprises, in addition, a circuit switched core (CS) network 39 and packet switched core (PS) network 40 which communicate with WCDMA and GSM radio networks. The circuit switched core network 39 comprises IWU (InterWorking Unit), MSC (Mobile Switching Centre) and GMSC (Gateway Mobile services Switching Centre) elements 41, 42 and 43 in order to connect WCDMA and GSM radio networks to a public switched telephone network 44 (PSTN). The packet switched core network 40 comprises 3G-SGSN (Serving GPRS Support Node) and 2G-SGSN elements 45 and 46, and an IP Backbone network 47 and a GGSN (Gateway GPRS Support Node) element 48 for connecting the WCDMA and GSM radio networks, for example, to the Internet 49.

The operation of different elements of telecommunications networks and their connections are prior art as such so they are not further discussed here.

According to an embodiment of the invention, mobile terminal 31 is capable of operating in networks according to both WCDMA and GSM technologies, and capable of operating in a home network and of roaming in one or more visited networks. The telecommunications network 30 shown in FIG. 3 is a visited network for the mobile terminal 31. The mobile terminal comprises control means, which are arranged to limit the operation of the mobile terminal in a network according to WCDMA technology, when the terminal is connected to the telecommunications network 30 in question. Thus the mobile terminal 31 connects to network 30 via a base station 36 of a radio network 35 according to GSM technology.

The above-described invention may facilitate the implementation of new network technologies, such as WCDMA technology. When network suppliers considered critical have finished their WCDMA network implementation, and the terminals are tested enough with the WCDMA network configurations of most operators, the situation is that also the roaming functionality of terminals may be secured in WCDMA networks. Then dual-system roaming may be activated in new terminals. That is, after this, the new terminals may also utilise WCDMA network when roaming in networks of other operators.

The invention is described above using the transfer from GSM technology to WCDMA technology as an example for illustrating the invention, but the invention is not, however, limited to this example only. It is clear for those skilled in the art that this invention may be utilised in context of any other applicable network technologies. The implementation and utilising possibilities of the invention are limited only by the appended patent claims. Thus the different implementation alternatives of the invention defined by the claims, also equivalent implementations, are within the scope of the invention.

What is claimed is:

1. A method for controlling roaming in a mobile terminal (20), which mobile terminal is capable of operating at least in networks according to first and second network technologies, and capable of operating in a home network and of roaming in one or more visited networks, said home network comprising at least a network according to said second network technology, and each visited network comprising at least a network according to one network technology, the method comprising:
controlling (12) the mobile terminal to operate in a home network mainly in a network according to said second network technology, and
limiting (13), at least in one visited network, the operation of said mobile terminal in a network according to said second network technology.

2. A method according to claim 1, wherein said home network comprises a network according to said first network technology, and a network according to said second network technology, and the method further comprising
controlling the mobile terminal to operate in a home network in a network according to said first network technology, if the network resources of said second network technology are not available.

3. A method according to claim 1, further comprising:
registering (10) into a new network,
checking (11), if said new network is a home network or a visited network, and
controlling (12, 13) dynamically said mobile terminal to operate according to the first or the second network technology, if said new network is a home network, and according to the first technology, if said new network is a visited network.

4. A method according to claim 3, wherein the checking phase is performed by comparing a network country code or a PLMN code obtained from the network in the registering phase with network information saved on a SIM/USIM card or a memory of the mobile terminal.

5. A method according to claim 1, wherein at least one of said visited network comprises a network according to said first network technology and a network according to said second network technology.

6. A method according to claim 1, wherein said second network technology is a network technology according to 3GPP standard.

7. A method according to claim 1, wherein said first network technology is a network technology according to GSM standard.

8. A method according to claim 1, wherein said first network technology is a network technology according to GPRS standard.

9. A mobile terminal (20, 31), having means for operating at least in networks according to first and second network technologies, and capable of operating in a home network and of roaming in one or more visited networks, said home network comprising at least a network according to said second network technology, and each visited network comprising at least a network according to one network technology, said mobile terminal further comprising
control means for controlling the mobile terminal to operate in a home network mainly in a network according to said second network technology, which control means are arranged to limit, at least in one visited network, the operation of the mobile terminal in a network according to said second network technology.

10. A mobile terminal according to claim 9, further comprising
means for registering into a new network,
checking means, which are arranged to check, if said new network is a home network or a visited network, and wherein
said control means are arranged to dynamically control said mobile terminal to operate according to the first or the second network technology, if said new network is a home network, and according to the first technology, if said new network is a visited network.

11. A mobile terminal according to claim 10, wherein the checking means are arranged to perform the checking by comparing a network country code or a PLMN code obtained from the network in the registering phase with the network information saved on a SIM/USIM card or a memory of the mobile terminal.

12. A computer program to be run in a mobile terminal (20, 31), which mobile terminal is capable of operating at least in networks according to first and second network technologies, and capable of operating in a home network and of roaming in one or more visited networks, said home network comprising at least a network according to said second network technology, and each visited network comprising at least a network according to one network technology, the computer program comprising
a program code, which controls the mobile terminal to operate in a home network mainly in a network according to said second network technology, and
a program code, which limits, at least in one visited network, the operation of the mobile terminal in a network according to said second network technology.

13. A computer program according to claim 12, further comprising
a program code for registering into a new network,
a program code, which is arranged to check, if said new network is a home network or a visited network, and
a program code, which is arranged to dynamically control said mobile terminal to operate according to the first or the second network technology, if said new network is a home network, and according to the first technology, if said new network is a visited network.

14. A computer program according to claim 13, wherein the program code, which is arranged to check if said new network is a home network or a visited network, is arranged to perform the checking by comparing a network country code or a PLMN code obtained from the network in the registering phase with the network information saved on a SIM/USIM card or a memory of the mobile terminal.

15. A telecommunications system comprising at least one telecommunications network (30), which comprises at least networks (32, 35) according to the first and the second network technology, the telecommunications system further comprising
a mobile terminal (31), which is capable of operating at least in networks according to the first and second network technologies, and capable of operating in a home network and of roaming in one or more visited networks, said telecommunications network (30) being a visited network for the mobile terminal, the mobile terminal (31) further comprising
control means, which are arranged to limit the operation of said mobile terminal in a network according to said second network technology when said terminal is connected to said telecommunications network (30).
